(19) United States
(12) Patent Application Publication
(10) Pub. No.: US 2008/0093442 A1
(43) Pub. Date: Apr. 24, 2008

(54) Financial transaction system with asset building benefit

(76) Inventor: Michael Hendricks, Baltimore, MD (US)

Correspondence Address: Jerome J. Norris, Suite 305, 1901 Pennsylvania Ave, N.W., Washington, DC, 20006, US

(21) Appl. No.: 11/581,415

(22) Filed: Oct. 17, 2006

(51) Int. Cl. G06K 5/00; G06Q 40/00

(52) U.S. Cl. 235/380; 705/35

(57) ABSTRACT

A tax and estate planning, asset building financial processing system, that enables a credit card holder to build wealth by accumulating assets without the need of credits or rebates based upon a percentage of sale amounts from merchants, comprising:
a) means for establishing a savings account for an account holder that entitles the account holder to a credit card;
b) means for utilizing a first portion of the savings account to purchase an insurance policy for the account holder, and contemporaneous means for creating a trust and designating proceeds from the insurance policy to the trust as trust assets;
i) and wherein cash proceeds from the insurance policy are distributed at the death of the insured to a beneficiary for a term of years or for life and proceeds from the remainder of the trust is donated to a tax exempt charitable organization;
c) means to enable the credit card holder to allocate a second portion of the savings account to a management company to invest in a capital asset to accumulate wealth; and
d) distribution means for sending back to the savings account of the card holder a portion of the accumulated asset value as monetary proceeds.

### FIELD OF THE INVENTION

The present invention pertains to a financial transaction system, and more particularly, to a financial processing system and method for allowing a card holder to have all or a portion of a credit or other consumer transaction managed based upon his participation in a savings account. The financial transaction savings system is of particular benefit in wealth creation, tax and estate planning, investments, retirement, and consumer spending to provide choices for the card holder's personal financial prerogatives.

### BACKGROUND OF THE INVENTION

Banking systems everywhere are moving forward toward cashless devices for consumer and commercial transactions. The common cashless device is the credit card, which is issued by banks or other organizations.

Conventional credit cards are issued by VISA, MASTERCARD, and AMERICAN EXPRESS companies, and these companies have a network of participating merchants that accept the cards. Banks and other financial institutions service the amounts and consumers can charge goods and services at participating merchants and the participating merchants then pay a percentage of the transaction to the credit card company.

To promote use of a specific credit card and to influence merchants to participate, card issuers rely on marketing techniques that offer special discounts or other benefits to users if they buy particular products or services. For example, the DISCOVER card issuer rebates a small percentage to the consumer, in the order of a few percent.

On the other hand, AMERICAN EXPRESS utilizes a memberships rewards program for card holders for travel benefits, retail benefits, lifestyle/entertainment benefits and a year-end summary of charges to assist the card holder in financial management.

Other promotional devices may include credits based on credit card activity which can be used when purchasing large items like vehicles.

Cards other than the conventional credit card may also be used. For example, shopping loyalty cards and frequent shopper cards, may be issued to customers by grocery chains as an alternative to paper coupons. These cards build loyalty by offering customers discounts. When the customer presents the card at the time of purchase the card is scanned and specific items are discounted. These cards utilize a database and thereby avoid the need for cashiers to visually and electronically scan coupons. In addition to building customer loyalty they provide information on customer buying habits and provide the store with valuable information to assist in marketing its products.

Another type of card is known as the SMART card or e-card. As another alternative to the use of hard currency, the SMART card stores funds digitally and thereby functions like an automated teller. The SMART card is generally personalized and protected by an identification system, such as a PIN number, photograph, or fingerprint. Further, the SMART card functions like cash in that its value is stored on a computer chip buried in the card and the stored value is lessened by the amount of the purchase when the card is used. A further advantage of the SMART card is that a retailer may use a PC based cash register to subtract payments from the card.

A further kind of financial card used is a DEBIT card that is presented to a cashier and the card is electronically swiped. At that time, the user may authorize a deduction from a checking account in the amount of the purchase or in addition to the purchase in order to obtain cash.

One deficiency or shortcoming with existing financial credit cards including debit and credit cards offered is that, consumers pay interest and fees to credit lenders, but do not accumulate wealth while they pay bills using their financial debit/credit cards—other than through the advent of rebates or refunds—which is in fact their own money.

Nevertheless, rebate and refund systems are known in the prior art.

### THE PRIOR ART

U.S. Pat. No. 4,750,119 utilizes a purchasing system with a rebate that allows input of purchase orders and correlates transfer of funds from consumers to retailers. A future benefit guarantor supplies the rebate which is input into the system. The system computes and reports the rebate due in the future to each subscriber. The system also provides instructions to pay the vendors for goods and services and pay the future rebate guarantor a premium representing the purchase price of future guaranteed rebates. The premium is paid on a daily basis to the guarantor and a group annuity contract is funded.

A centralized computer cash value accumulation system based on point of sale transactions with multiple merchants is disclosed in U.S. Pat. No. 4,941,090. The consumer's account number and birth date are transmitted to a central system along with data identifying the merchant and a credit line determined by the merchant. At a central location, a cash value for the consumer is incremented by the credit value and a bill for that merchant is incremented. The merchants are billed for the accumulated bill value on a periodic basis. In selected intervals, consumers are given access to their accumulated cash values by either check or through funds dispensed electronically.

U.S. Pat. No. 5,537,314 disclose a credit accumulation and accessing system for a plurality of sponsors and participants. Under the control of an operational program, several tasks are accomplished including creating sub-directories for a single participant account so as to selectively associate the single account sub-directory with multiple sponsoring company accounts in deciphering and, at points of sale, calculating, posting and issuing discounts, raffle entries, store credit returns, points and cash values with the performance of participants. Award output devices provide consumers access to funds based upon the cash value in the consumer account and can include wire transfer, check, cash coupon, charge card balance reduction or catalog merchandise.

### SUMMARY OF THE INVENTION

One object of the present invention is to provide a financial services card with asset building benefits to the card holder that is proportional to monies which the card holder has contributed to a bank savings account.

Another object of the invention is to provide a SMART CARD known as “THE LEGACY” as an asset building tool for wealth creation and estate planning, wherein a portion of the monies in the savings account of the card holder is used to secure a life insurance policy naming a beneficiary, and wherein contemporaneously therewith, the card holder establishes a trust fund designating proceeds from the insurance policy as trust assets and appointing a non-profit, tax exempt, charitable organization as remainderman. At the death of the indvidual/cardholder/settlor, the beneficiary receives cash proceeds for a term or life, and thereafter, the charitable remainderman receives the balance of the trust.

A further object of the invention is to provide a SMART CARD known as “THE LEGACY”, that allows another portion of the savings account of the card holder to be invested in a capital investment, a business or other property and managed by a management company in accordance with contractual provisions of the savings account banks issuing the SMART CARD.

A yet further object of the invention is to provide a SMART CARD associated with a savings account that enables the card holder to also utilize the card as a credit card, debit card or other type of financial services card consistent with the value of the amount in the savings account plus the value of the asset in which a portion of the savings account has been invested by the designated management company to generate accumulated wealth in excess of the initial savings.

Other objects of the invention will become apparent by reference to the specification, Brief Description Of The Drawings and Detailed Description Of The Preferred Embodiment Of The Invention.

### BRIEF DESCRIPTION OF THE DRAWINGS

FIG. 1 is a schematic diagram depicting the basic system of the present invention.

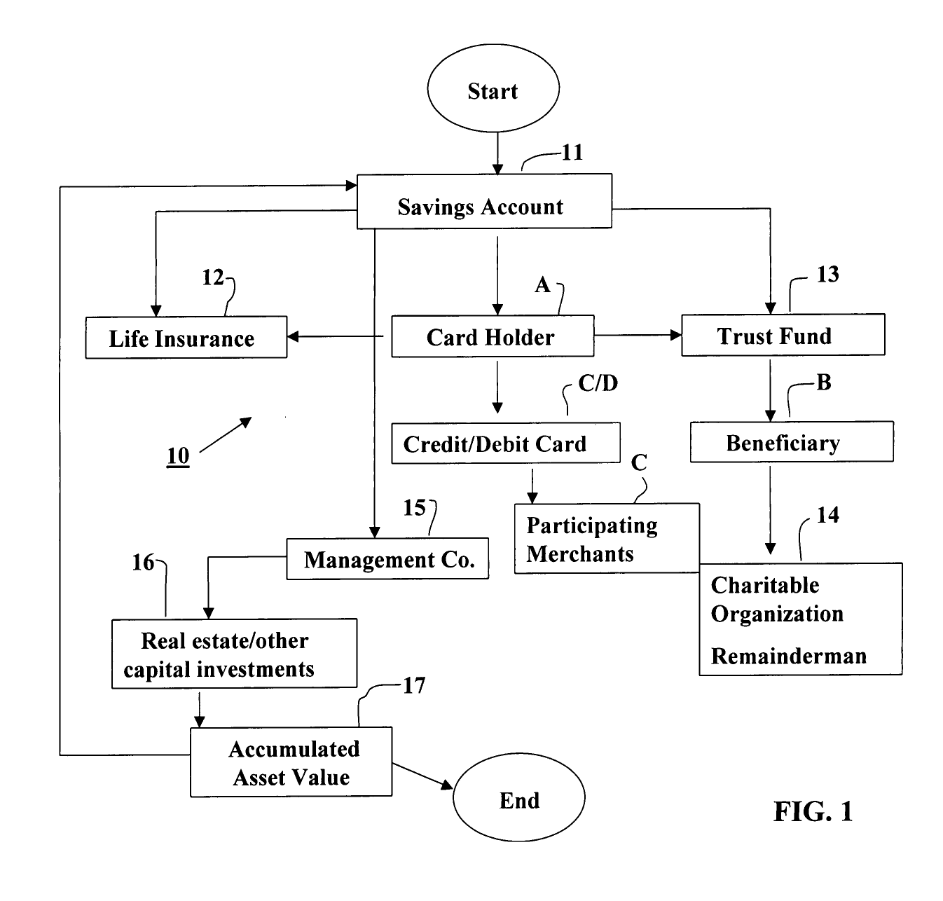

Referring to FIG. 1, there is shown a financial processing system 10 in which a consumer starts a savings account 11 that ultimately grows into an accumulated asset value 17. A portion of the amount saved is utilized to purchase an insurance policy 12, which may be term or whole life or any of the varying types of combinations or conversion life insurance policies. Contemporaneously therewith, the card holder under an agreement with the bank must establish a trust fund 13 designating proceeds from the insurance policy as the trust assets. In establishing the trust fund, the now individual/cardholder/settlor designates a beneficiary B and a non-profit, tax exempt, charitable organization as the remainderman 14. At the death of the individual/cardholder/settlor, the beneficiary B receives cash proceeds from the insurance policy for a term of years or for life, depending on the terms of the trust instrument. Once the beneficiary's interest in the trust expires, the charitable organization remainderman begins to receive proceeds of the trust.

Under the terms of the Financial Transaction Savings System, THE LEGACY card holder A may select a management company 15 to invest a portion of the savings account into capital assets such as real estate, stocks, bonds, or to purchase corporations 16 that may be employee owned together with other LEGACY CARD holders by virtue of pooling savings accounts. The management company may attract grants or matching funds if the management entity and cardholders qualify for such.

Alternatively, the LEGACY CARD holder may utilize the card as a credit or debit card C/D with participating merchants C that accept the card. The participating merchants may be conventional retail merchants such as supermarkets, department stores, restaurants and the like, or doctors, lawyers and other professionals. Although the advantages of the system are not obtained by virtue of any credits or rebates based on a percentage of sale amounts from merchants, the system does not preclude the additional use of credits and rebates as a percentage of sales if the participating merchants agree to such with the card issuer.

A portion of the accumulated asset value may be sent back to the savings account of the cardholder upon request, as proceeds.

### DETAIL DESCRIPTION OF PREFERRED EMBODIMENTS OF THE INVENTION

The present invention provides a system based on its SMART card, known as “THE LEGACY” as an asset building tool for wealth creation, tax and estate planning, investment, retirement and consumer spending in addition to saving to resolve a card holder's personal financial prerogatives. The unique financial service bestowed upon the holder of “THE LEGACY” card allows the card holder to save as they spend without the need for credits and rebates as a necessity.

“THE LEGACY” card works in tandem with a trust plan as follows:

Initially the card holder takes out a life insurance policy from a portion of the savings account. Contemporaneously therewith, the individual/card holder establishes a trust fund designating the proceeds from the insurance policy as the trust's assets. The individual/cardholder/settlor designates a loved one as a beneficiary and a non-profit, tax exempt, charitable organization as remainderman. At the death of the settlor the beneficiary receives cash proceeds from the policy for a term of years or for life, depending on the terms of the trust instrument. Once the beneficiary's interest in the trust expires the charitable remainderman begins to receive proceeds of the trust.

Applicable trust law and the Internal Revenue Code appears to allow this system to be a viable and extremely efficient means to deliver gifts. The very definition of a trust instrument, i.e., the right, enforceable solely in equity to the beneficial enjoyment of property, the legal title to which is vested in another C.J.S. Trusts Sections 2, makes it an ideal mechanism for charitable giving.

The concepts of Charitable Remainder Annuity Trust and Charitable Remainder Unitrust are defined in the Internal Revenue Code section 664(d)(1)(2). Moreover, the trust itself is exempt from federal income tax; see Internal Revenue Code Section 664(c). Additional tax advantages are inter alia:

1. Donor receives a federal gift tax deduction for gifts made to a charitable remainder annuity trust, charitable remainder unitrust, and pooled income fund; I.R.C. section 2522(c)(2)(a).

2. Donor's decedent estate receives federal estate tax deduction when assets are transferred to a 501(c)(3) tax exempt organization; I.R.C. section 2055(a)(2) and (e)(2)(a)

3. Proceeds of a life insurance policy that are payable to the income beneficiary “by reason of death of the insured,” are excludable from the gross income of the beneficiary, i.e., tax free; see I.R.C. Section 101(a) and

4. Ostensibly, Internal Revenue Code section 170(f)(2)(a) allows a charitable deduction for income tax purposes of insurance premiums paid by the Insured/Settlor.

As long as the trust instrument established as part of the Plan conforms to the requirements of the Internal Revenue Code, individual and charitable organizations will enjoy the advantages above mentioned. Moreover, donors will have an opportunity to efficiently manifest their donative intent in a way which allows beneficiaries and charities to receive the maximum benefits of their gifts.

Although the principles of the invention have been made clear in an illustrative embodiment, it will become obvious to those skilled in the art to make various modifications to the structure, arrangement, elements, materials and components used in the practice of the invention without departing from the spirit and scope of the appended claims herewith.

I claim:

1. A tax and estate planning, asset building financial processing system, that enables a credit card holder to build wealth by accumulating assets without the need of credits or rebates based upon a percentage of sale amounts from merchants, comprising:
a) means for establishing a savings account for an account holder that entitles the account holder to a credit card;
b) means for utilizing a first portion of said savings account to purchase an insurance policy for said account holder, and contemporaneous means for creating a trust and designating proceeds from said insurance policy to said trust as trust assets;
i) and wherein cash proceeds from the insurance policy are distributed at the death of the insured to a beneficiary for a term of years or for life and proceeds from the remainder of the trust is donated to a tax exempt charitable organization;
c) means to enable said credit card holder to allocate a second portion of said savings account to a management company to invest in a capital asset to accumulate wealth; and
d) distribution means for sending back to said savings account of said card holder a portion of the accumulated asset value or wealth as monetary proceeds.

2. The financial processing system of claim 1 wherein said credit card is a Smart Card that stores information concerning the account.

3. The financial processing system of claim 2 wherein the Smart Card includes security features.

4. The financial processing system of claim 3 comprising means to enable said card holder to purchase goods and services from a participating supplier.

5. The financial processing system of claim 4 wherein said purchase is paid by electronic transfer.

6. The financial processing system of claim 4 wherein said purchase is made by a Smart Card that is a debit card.

7. The financial processing system of claim 4 wherein said purchase is made by a Smart Card that is a credit card.

8. The financial processing system of claim 1 wherein said insurance policy is a term life insurance policy.

9. The financial processing system of claim 1 wherein said insurance policy is a whole life insurance policy.

10. The financial processing system of claim 1 wherein said capital asset is real estate.

11. The financial processing system of claim 1 wherein said capital asset is stocks.

12. The financial processing system of claim 1 wherein said capital asset is bonds.

13. The financial processing system of claim 1 wherein said capital asset is a corporation.

14. The financial processing system of claim 13 wherein said corporation is an employee owned corporation.
